(19) United States
(12) Patent Application Publication
(10) Pub. No.: US 2019/0101111 A1
(43) Pub. Date: Apr. 4, 2019

(54) FLUID SYSTEM

(71) Applicant: Microjet Technology Co., Ltd., Hsinchu (TW)

(72) Inventors: Hao-Jan MOU, Hsinchu (TW); Chi-Feng HUANG, Hsinchu (TW); Yung-Lung HAN, Hsinchu (TW); Hsuan-Kai CHEN, Hsinchu (TW)

(73) Assignee: Microjet Technology Co., Ltd., Hsinchu (TW)

(21) Appl. No.: 16/110,303

(22) Filed: Aug. 23, 2018

(30) Foreign Application Priority Data
Sep. 29, 2017 (TW) 106133653

(51) Int. Cl. F04B 43/04; F16K 99/00

(52) U.S. Cl. CPC F04B 43/046; F16K 99/0048; F16K 2099/0098; F16K 2099/0084; F16K 2099/0092

(57) ABSTRACT

A fluid system includes a fluid actuating region, a fluid channel, a convergence chamber, a sensor and a plurality of valves. The fluid actuating region includes one or a plurality of fluid-guiding units. Each of the fluid-guiding units includes an inlet plate, a substrate, a resonance plate, an actuating plate, a piezoelectric member and an outlet plate, which are stacked sequentially. When the piezoelectric member drives the actuating plate to undergo a bending vibration in resonance, the fluid is transported into the fluid-guiding units and is pressurized to be discharged out. The fluid channel has a plurality of branch channels for splitting the fluid transported in the fluid actuating region. The convergence chamber is in communication with the fluid channel. The sensor is disposed in the fluid channel for measuring the fluid within the fluid channel.

### FIELD OF THE INVENTION

The present disclosure relates to a fluid system, and more particularly to a miniature integrated fluid system.

### BACKGROUND OF THE INVENTION

Nowadays, in various fields such as pharmaceutical industries, computer techniques, printing industries or energy industries, the products are developed toward elaboration and miniaturization. The fluid transportation devices are important components that are used in, for example micro pumps, micro atomizers, print heads and industrial printers. Therefore, how to utilize an innovative structure to break through the bottleneck of the prior art has become an important part of development.

With the rapid development of science and technology, the applications of the fluid transportation devices are becoming more and more diversified. For example, the fluid transportation devices are gradually popular in industrial applications, biomedical applications, medical care applications, electronic cooling applications and so on, or even the popular wearable devices. It is obvious that the fluid transportation devices gradually tend to miniaturize the structure and maximize the flow rate thereof.

Although the miniature fluid transportation device is capable of transporting fluid continuously, still some drawbacks are existed. For example, it is difficult to increase the amount of fluid to be transported due to the limited capacity of the chamber or the design of the fluid channel of the miniature fluid transportation device. For solving the above drawbacks, it is important to provide a fluid transportation device having a valve not only for controlling the continuation or interruption of the fluid transportation, but also for controlling the fluid to flow unidirectionally. In addition, the fluid is accumulated in the limited-capacity chamber or fluid channel for increasing the amount of the fluid to be discharged.

### SUMMARY OF THE INVENTION

An object of the present disclosure is to provide a fluid system produced by an integrated method to address the issues that the prior arts can't meet the requirements of the miniature fluid system. The fluid system includes a fluid actuating region, a fluid channel, a convergence chamber, a sensor and a plurality of valves. The fluid actuating region includes at least one fluid-guiding unit. The fluid-guiding unit includes an inlet plate, a substrate, a resonance plate, an actuating plate, a piezoelectric member and an outlet plate. The inlet plate has an inlet aperture. The resonance plate has a central aperture. A first chamber is formed between the resonance plate and the inlet plate. The actuating plate has a suspension part, an outer frame part and at least one interspace. The piezoelectric member is attached on a surface of the suspension part of the actuating plate. The outlet plate has an outlet aperture. The inlet plate, the substrate, the resonance plate, the actuating plate and the outlet plate are stacked sequentially. A gap formed between the resonance plate and the actuating plate is defined as a second chamber. A third chamber is formed between the actuating plate and the outlet plate. While the piezoelectric member drives the actuating plate to undergo a bending vibration in resonance, a pressure difference is formed between the second chamber and the third chamber so that fluid is inhaled into the first chamber through the inlet aperture of the inlet plate, is transported to the second chamber through the central aperture of the resonance plate, is transported to the third chamber through the at least one interspace, and is finally discharged out from the outlet aperture of the outlet plate. The fluid channel is in communication with the outlet aperture of the fluid actuating region and has a plurality of branch channels for splitting the fluid transported in the fluid actuating region so that a required amount of the fluid to be transported is determined. The convergence chamber is in communication with the fluid channel for allowing the fluid to be accumulated therein. The sensor is disposed in the fluid channel for measuring the fluid within the fluid channel. The valves are respectively disposed in the branch channels. The fluid is discharged out through the branch channels according to opened/closed states of the valves.

In some embodiments, the fluid system further includes a controller electrically connected to the valves to control the valves to be in the opened/closed states. The controller and the at least one fluid-guiding unit are systematically packaged as an integrated structure. The fluid actuating region includes a plurality of fluid-guiding units. The fluid-guiding units are connected to each other in series, in parallel or in both series and parallel. The lengths and widths of the branch channels are preset according to the required amount of the fluid to be transported. The branch channels are connected to each other in series, in parallel or in both series and parallel. From the above descriptions, the fluid system of the present disclosure is capable of outputting the required amount of the fluid having particular flow rate and under particular pressure.

In some embodiments, each of the valves includes a base, a piezoelectric actuator and a linking rod. The base has a first passage and a second passage, which are separated from each other, and which are in communication with a corresponding one of the branch channels. The piezoelectric actuator includes a carrier plate and a piezoelectric ceramic plate. The piezoelectric ceramic plate is attached on a first surface of the carrier plate. A valve chamber is formed between the piezoelectric actuator and the base, and has a first outlet and a second outlet. The linking rod has a first end connected to a second surface of the carrier plate and extends into the second outlet, and is movable within the second outlet. A sealing part is formed at a second end of the linking rod for sealing the second outlet, wherein the sealing part has a cross-sectional area with a diameter greater than a diameter of the second outlet. When the piezoelectric actuator is driven to drive a deformation of the carrier plate, the sealing part of the linking rod is correspondingly moved to close or open the second outlet, so that the fluid is controlled to be discharged out through the corresponding one of the branch channels. Through the above-mentioned actuation, each of the valves allows the corresponding branch channel to be opened when the piezoelectric actuator is not driven, and allows the corresponding branch channel to be sealingly closed when the piezoelectric actuator is driven. Alternatively, each of the valves allows the corresponding branch channel to be sealingly closed when the piezoelectric actuator is not driven, and allows the corresponding branch channel to be opened when the piezoelectric actuator is driven.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic system diagram illustrating a fluid system according to some embodiments of the present disclosure;

FIG. 2 is a schematic structural view illustrating a first aspect of a fluid actuating region of the fluid system;

FIG. 3A is a schematic cross-sectional view illustrating a fluid-guiding unit of the fluid system;

FIGS. 3B, 3C and 3D are schematic diagrams illustrating actuations of the fluid-guiding unit of the fluid system;

FIG. 4A is a schematic cross-sectional view illustrating that a plurality of fluid-guiding units are connected to each other in series;

FIG. 4B is a schematic cross-sectional view illustrating that the fluid-guiding units are connected to each other in parallel;

FIG. 4C is a schematic cross-sectional view illustrating that the fluid-guiding units are connected to each other both in series and in parallel;

FIG. 5 is a schematic structural view illustrating a second aspect of the fluid actuating region of the fluid system;

FIG. 6 is a schematic structural view illustrating a third aspect of the fluid actuating region of the fluid system;

FIGS. 7A and 7B are schematic cross-sectional views illustrating actuations of a first aspect of a valve of the fluid system; and

FIGS. 8A and 8B are schematic cross-sectional views illustrating actuations of a second aspect of the valve of the fluid system.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

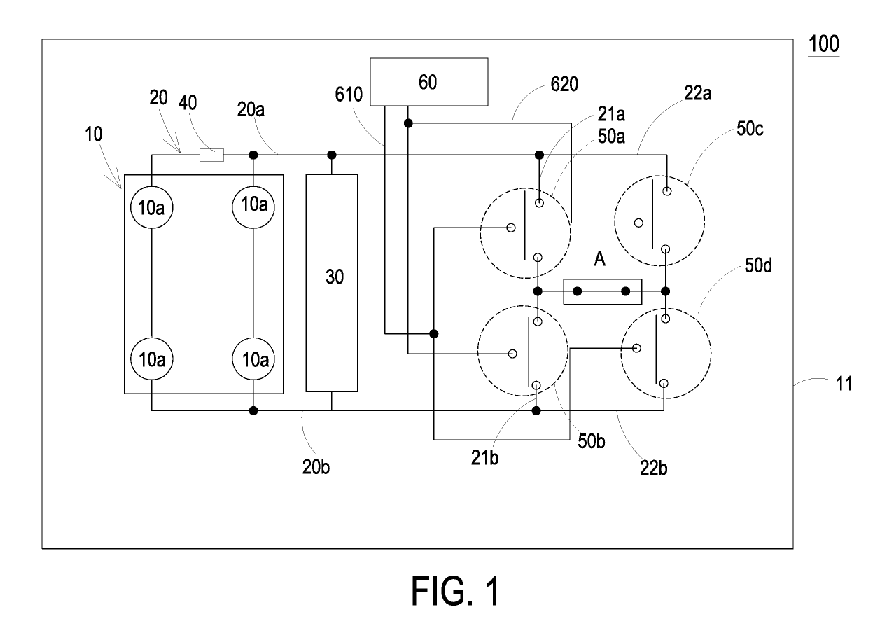

Referring to FIGS. 1, 2, 3A, 3B, 3C and 3D, the present discourse provides a fluid system 100 including at least one fluid actuating region 10, at least one fluid-guiding unit 10a, at least one inlet plate 17, at least one inlet aperture 170, at least one substrate 11, at least one resonance plate 13, at least one central aperture 130, at least one first chamber 12, at least one actuating plate 14, at least one suspension part 141, at least one outer frame part 142, at least one interspace 143, at least one piezoelectric member 15, at least one outlet plate 16, at least one outlet aperture 160, at least one gap g0, at least one second chamber 18, at least one third chamber 19, at least one pressure difference, at least one fluid channel 20, at least one convergence chamber 30, at least one sensor 40 and a plurality of valves 50, 50a, 50b, 50c and 50d. The number of the fluid actuating region 10, the inlet plate 17, the substrate 11, the resonance plate 13, the central aperture 130, the first chamber 12, the actuating plate 14, the suspension part 141, the outer frame part 142, the piezoelectric member 15, the outlet plate 16, the outlet aperture 160, the gap g0, the second chamber 18, the third chamber 19, the pressure difference, the fluid channel 20, the convergence chamber 30 and the sensor 40 is exemplified by one for each in the following embodiments but not limited thereto. It is noted that each of the fluid actuating region 10, the inlet plate 17, the substrate 11, the resonance plate 13, the central aperture 130, the first chamber 12, the actuating plate 14, the suspension part 141, the outer frame part 142, the piezoelectric member 15, the outlet plate 16, the outlet aperture 160, the gap g0, the second chamber 18, the third chamber 19, the pressure difference, the fluid channel 20, the convergence chamber 30 and the sensor 40 can also be provided in plural numbers.

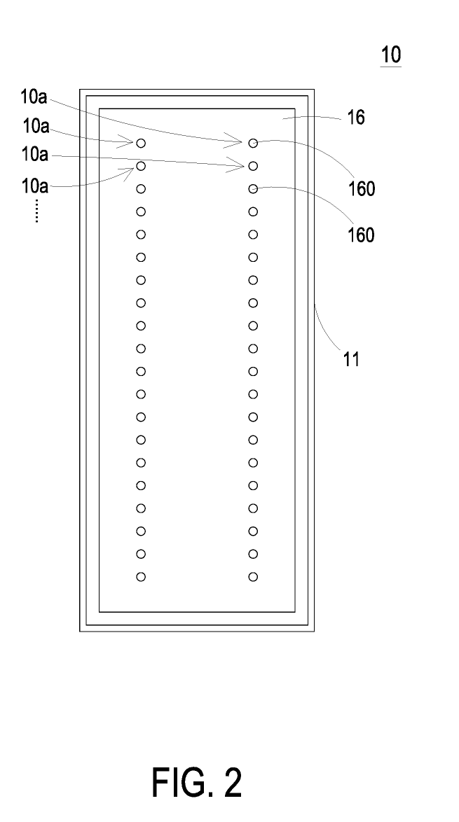

FIG. 1 is a schematic system diagram illustrating a fluid system according to some embodiments of the present disclosure. FIG. 2 is a schematic structural view illustrating a first aspect of a fluid actuating region of the fluid system. Referring to FIGS. 1 and 2, the fluid system 100 includes a fluid actuating region 10, a fluid channel 20, a convergence chamber 30, a sensor 40, a plurality of valves 50a, 50b, 50c and 50d, and a controller 60. In some embodiments, the fluid actuating region 10, the fluid channel 20, the convergence chamber 30, the sensor 40, the valves 50a, 50b, 50c and 50d, and the controller 60 are systematically packaged on a substrate 11 to form a miniature integrated structure. In other words, the fluid system 100 is produced by an integrated method. The fluid actuating region 10 includes one or a plurality of fluid-guiding units 10a. The fluid-guiding units 10a are connected to each other in series, in parallel or both in series and in parallel. When each of the fluid-guiding units 10a is driven, a pressure difference within each of the fluid-guiding units 10a is formed, by which fluid (e.g., gas) is inhaled into each of the fluid-guiding units 10a and is pressurized to be discharged out from an outlet aperture 160 of each of the fluid-guiding units 10a. Consequently, the object of fluid transportation is achieved.

As shown in FIG. 2, a first aspect of the fluid actuating region 10 includes a plurality of fluid-guiding units 10a. The amount of the fluid to be discharged from the fluid actuating region 10 is adjusted according to the arrangement of the fluid-guiding units 10a. In some embodiments, the fluid-guiding units 10a are mounted to the substrate 11 and connected to each other both in series and in parallel.

In some embodiments, the fluid actuating region 10 includes four fluid-guiding units 10a. The four fluid-guiding units 10a are connected to each other both in series and in parallel. The fluid channel 20 is in communication with the outlet apertures 160 of the fluid-guiding units 10a to discharge the fluid from the fluid-guiding units 10a. The structures, actuations and dispositions of the fluid-guiding units 10a and the fluid channel 20 will be described as follows. The fluid channel 20 has a plurality of branch channels 20a and 20b for splitting the fluid discharged from the fluid actuating region 10. Consequently, the required amount of the fluid to be transported is determined. The branch channels 20a and 20b are exemplified in the above embodiments, but the number of the branch channels is not restricted. The convergence chamber 30 is in communication with the branch channels 20a and 20b, and the convergence chamber 30 is therefore in communication with the fluid channel 20. In such a manner, the fluid is transported to, accumulated and stored in the convergence chamber 30. When the fluid system 100 is under control to discharge the required amount of the fluid, the convergence chamber 30 can supply the fluid to the fluid channel 20 so as to increase the amount of the fluid to be transported. In some embodiments, the sensor 40 is disposed in the fluid channel 20 for measuring the fluid within the fluid channel 20.

It should be noted that, the communication method of the above-mentioned branch channels 20a and 20b may vary. In some embodiments, the branch channels 20a and 20b are connected to each other in parallel. In some other embodiments, the branch channels 20a and 20b may be connected to each other in series. In some other embodiments, the branch channels 20a and 20b may also be connected to each other both in series and in parallel. The lengths and widths of the branch channels 20a and 20b are preset according to the required amount of the fluid to be transported. In other words, the flow rate and the amount of the fluid to be transported may vary based on the lengths and widths of the branch channels 20a and 20b. That is, the lengths and widths of the branch channels 20a and 20b may be calculated in advance according to the required amount of the fluid to be transported.

In some embodiments, the branch channel 20a has two sub-branch channels 21a and 22a, and the branch channel 20b has two sub-branch channels 21b and 22b. The sub-branch channels 21a and 22a of the branch channel 20a are connected to each other in series, in parallel, or both in series and in parallel. Similarly, the sub-branch channels 21b and 22b of the branch channel 20b are connected to each other in series, in parallel, or both in series and in parallel. The valves 50a, 50c, 50b and 50d may be active valves or passive valves. In some embodiments, the valves 50a, 50c, 50b and 50d are active valves, and are disposed in the sub-branch channels 21a, 22a, 21b and 22b, respectively. The communication state of the sub-branch channels 21a, 22a, 21b and 22b are respectively controlled by the valves 50a, 50c, 50b and 50d. For example, when the valve 50a is in an opened state, the sub-branch channel 21a is opened to discharge the fluid to an output region A, when the valve 50b is in the opened state, the sub-branch channel 21b is opened to discharge the fluid to the output region A, when the valve 50c is in the opened state, the sub-branch channel 22a is opened to discharge the fluid to the output region A, and when the valve 50d is in the opened state, the sub-branch channel 22b is opened to discharge the fluid to the output region A. The controller 60 includes two conductive wires 610 and 620. The conductive wire 610 is electrically connected to control terminals of the valves 50a and 50d, and the conductive wire 620 is electrically connected to control terminals of the valves 50b and 50c. Consequently, the opened states and closed states of the valves 50a, 50c, 50b and 50d can be controlled by the controller 60, so that the communication states of the sub-branch channels 21a, 22a, 21b and 22b are controlled by the controller 60 for allowing the fluid to be transported to the output region A.

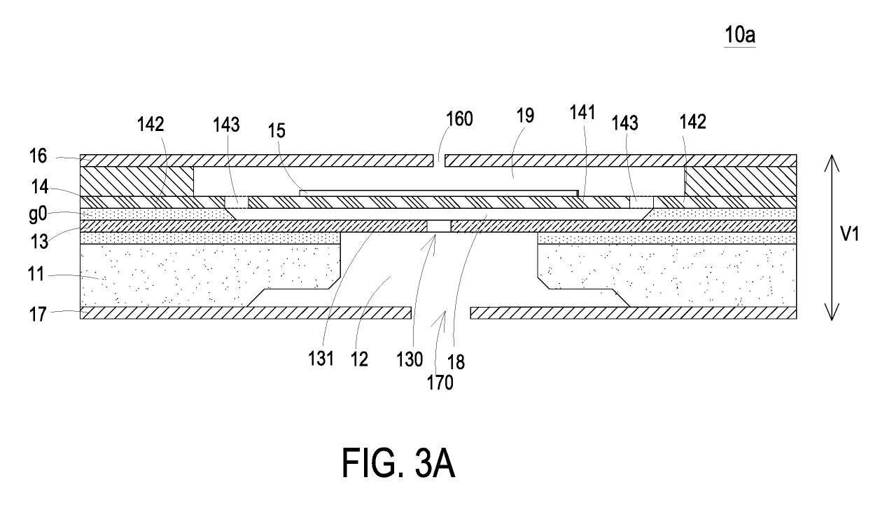

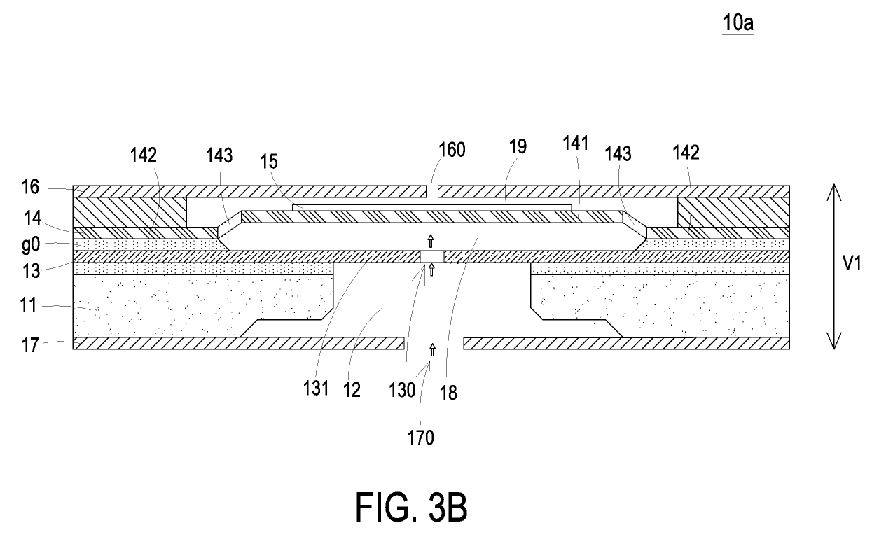

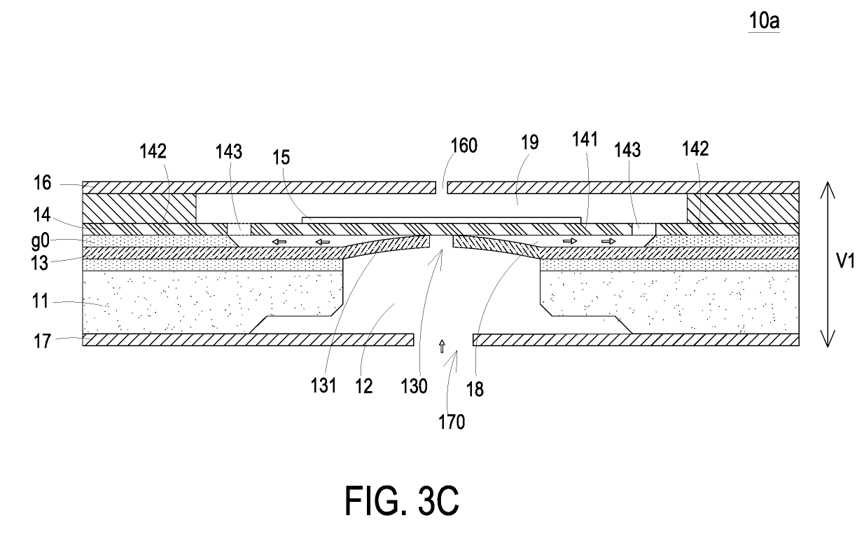

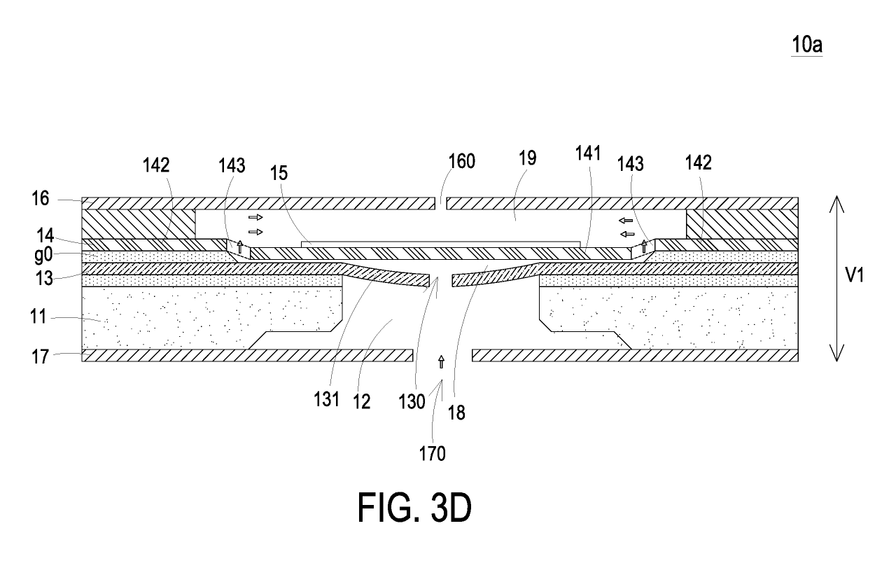

FIG. 3A is a schematic cross-sectional view illustrating a fluid-guiding unit of the fluid system. In some embodiments, each of the fluid-guiding units 10a is a piezoelectric pump. As shown in FIG. 3A, each of the fluid-guiding units 10a includes an inlet plate 17, the substrate 11, a resonance plate 13, an actuating plate 14, a piezoelectric member 15 and an outlet plate 16, which are stacked on each other sequentially. The inlet plate 17 has at least one inlet aperture 170. The resonance plate 13 has a central aperture 130 and a movable part 131. The movable part 131 is a flexible structure of the resonance plate 13 that is not fixedly attached on the substrate 11. The central aperture 130 is formed in a middle region of the movable part 131. A first chamber 12 is formed between the resonance plate 13 and the inlet plate 17. The actuating plate 14 has a suspension part 141, an outer frame part 142 and a plurality of interspaces 143. The suspension part 141 of the actuating plate 14 is connected to the outer frame part 142 through a plurality of connecting parts (not shown), so that the suspension part 141 is suspended and is elastically supported by the outer frame part 142. The interspaces 143 are defined between the suspension part 141 and the outer frame part 142 and are disposed for allowing the fluid to flow therethrough. The dispositions, the types and the numbers of the suspension part 141, the outer frame part 142 and the interspaces 143 may be varied according to the practical requirements, and are not limited thereto. Preferably but not exclusively, the actuating plate 14 is made of a metallic film or a polysilicon film, but is not limited thereto. Moreover, a gap g0 formed between the actuating plate 14 and the resonance plate 13 is defined as a second chamber 18. The outlet aperture 160 is formed in the outlet plate 16. A third chamber 19 is formed between the actuating plate 14 and the outlet plate 16. The first chamber 12 is in communication with the exterior of each of the fluid-guiding units 10a through the inlet aperture 170 of the inlet plate 17, and is in communication with the second chamber 18 through the central aperture 130 of the resonance plate 13. The second chamber 18 is in communication with the third chamber 19 through the interspaces 143. The third chamber 19 is in communication with the exterior of each of the fluid-guiding units 10a through the outlet aperture 160 of the outlet plate 16.

In some embodiments, the substrate 11 of each of the fluid-guiding units 10a further includes a driving circuit (not shown) electrically connected to the anode and the cathode of the piezoelectric member 15 so as to provide a driving power to the piezoelectric member 15, but is not limited thereto. In some other embodiments, the driving circuit may be disposed at any position within each of the fluid-guiding units 10a. The disposition of the driving circuit may be varied according to the practical requirements.

FIGS. 3B, 3C and 3D are schematic diagrams illustrating actuations of the fluid-guiding unit of the fluid system. As shown in FIG. 3A, each of the fluid-guiding units 10a is in a non-driven state (i.e. in an initial state). When the piezoelectric member 15 is driven in response to an applied voltage, the piezoelectric member 15 undergoes a bending deformation to drive the actuating plate 14 to vibrate in a first vertical direction (V1) in a reciprocating manner. As shown in FIG. 3B, as the suspension part 141 of the actuating plate 14 vibrates away from the inlet plate 17, the volume of the second chamber 18 is enlarged and the pressure in the second chamber 18 is reduced. The fluid is inhaled into each of the fluid-guiding units 10a through the inlet aperture 170 of the inlet plate 17 in response to the external pressure, and is then converged into the first chamber 12. Subsequently, the fluid is transported into the second chamber 18 through the central aperture 130 of the resonance plate 13.

As shown in FIG. 3C, the movable part 131 of the resonance plate 13 is driven to vibrate away from the inlet plate 17 in resonance with the vibration of the suspension part 141 of the actuating plate 14, and the suspension part 141 of the actuating plate 14 returns to its original position, where is the same position when each of the fluid-guiding units 10a is in the non-driven state, at the same time. In such a manner, the movable part 131 of the resonance plate 13 is attached to and abuts against the suspension part 141 of the actuating plate 14. As a result, the central aperture 130 of the resonance plate 13 is no longer in communication with the second chamber 18. Therefore, the second chamber 18 is compressed to reduce the volume thereof and increase the pressure therein, and the volume of the third chamber 19 is enlarged and the pressure in the third chamber 19 is reduced. Under this circumstance, the pressure gradient occurs to push the fluid in the second chamber 18 to move toward a peripheral portion of the second chamber 18, and to flow into the third chamber 19 through the interspaces 143 of the actuating plate 14. As shown in FIG. 3D, the suspension part 141 of the actuating plate 14 further vibrates toward the inlet plate 17 and drives the movable part 131 of the resonance plate 13 to synchronously vibrate toward the inlet plate 17, so as to further compress the first chamber 18. As a result, most of the fluid is transported into the third chamber 19 and is temporarily stored in the third chamber 19.

Finally, the suspension part 141 of the actuating plate 14 vibrates to its original position, where is the same position when each of the fluid-guiding units 10a is in the non-driven state, so as to compress the third chamber 19, the volume of the third chamber 19 is thereby reduced and the pressure in the third chamber 19 is thereby increased. Thus, the fluid stored in the third chamber 19 is discharged out to the exterior of each of the fluid-guiding units 10a through the outlet aperture 160 of the outlet plate 16 so as to accomplish a fluid transportation process. The above actuations and steps illustrated in FIGS. 3B, 3C and 3D indicate a complete cycle of the reciprocating vibration of the actuating plate 14. When the piezoelectric member 15 is driven, the suspension part 141 of the actuating plate 14 and the movable part 131 of the resonance plate 13 perform the above actuations repeatedly. Consequently, the fluid is continuously inhaled into the inlet aperture 170 and is pressurized to be discharged out through the outlet aperture 160. In such way, the purpose of the fluid transportation is achieved. In some embodiments, a vibration frequency of the resonance plate 13 is identical to a vibration frequency of the actuating plate 14. That is, the resonance plate 13 and the actuating plate 14 can synchronously vibrate in the same direction. It is noted that numerous modifications and alterations of the actuations of the fluid-guiding units 10a may be made while retaining the teachings of the disclosure.

As a result, the pressure gradient formed in the fluid channels of the fluid-guiding units 10a facilitate the fluid to flow at a high speed. Moreover, since there is an impedance difference between an inlet direction and an outlet direction, the fluid can be transported from an inhale end to a discharge end of each of the fluid-guiding units 10a. Moreover, even if a gas pressure exists at the discharge end, each of the fluid-guiding units 10a still has the capability to discharge out the fluid while achieving the silent efficacy.

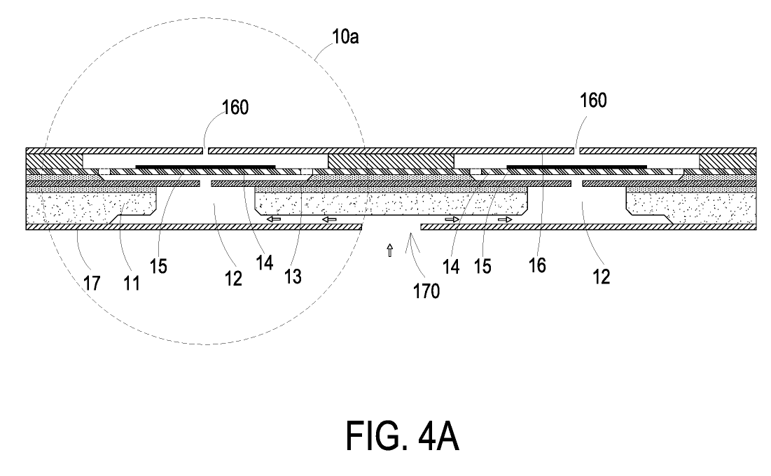

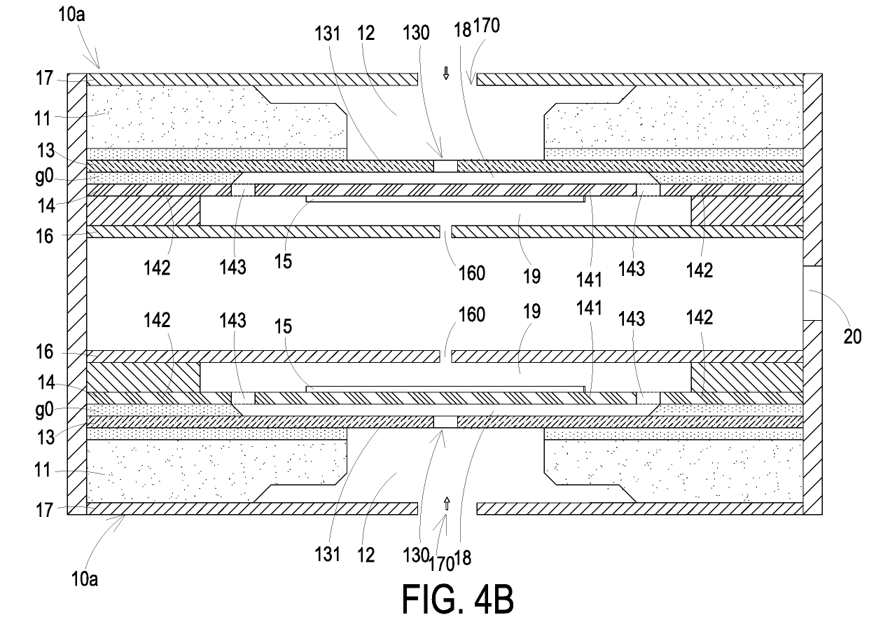

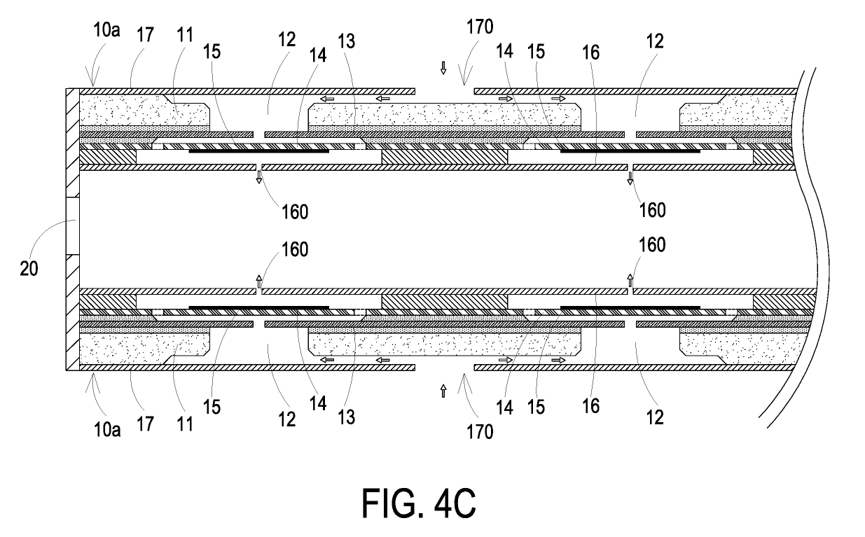

FIG. 4A is a schematic cross-sectional view illustrating that a plurality of fluid-guiding units are connected to each other in series. FIG. 4B is a schematic cross-sectional view illustrating that the fluid-guiding units are connected to each other in parallel. FIG. 4C is a schematic cross-sectional view illustrating that the fluid-guiding units are connected to each other both in series and in parallel. As shown in FIG. 4A, the fluid-guiding units 10a of the fluid actuating region 10 are connected to each other in series. Since the fluid-guiding units 10a are connected to each other in series, the pressure of the fluid at the outlet apertures 160 of the fluid actuating region 10 is increased. As shown in FIG. 4B, the fluid-guiding units 10a of the fluid actuating region 10 are connected to each other in parallel. Since the fluid-guiding units 10a are connected to each other in parallel, the amount of the fluid to be discharged out from the outlet apertures 160 of the fluid actuating region 10 is increased. As shown in FIG. 4C, the fluid-guiding units 10a of the fluid actuating region 10 are connected to each other both in series and in parallel. Consequently, the pressure of the fluid and the amount of the fluid to be discharged out from the fluid actuating region 10 are increased.

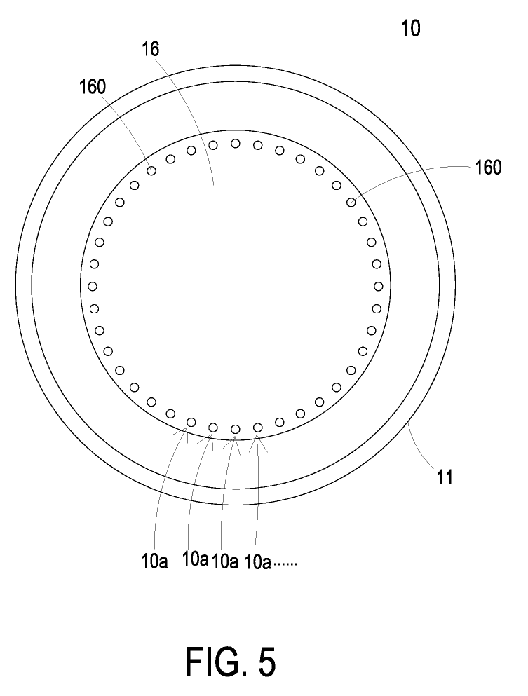

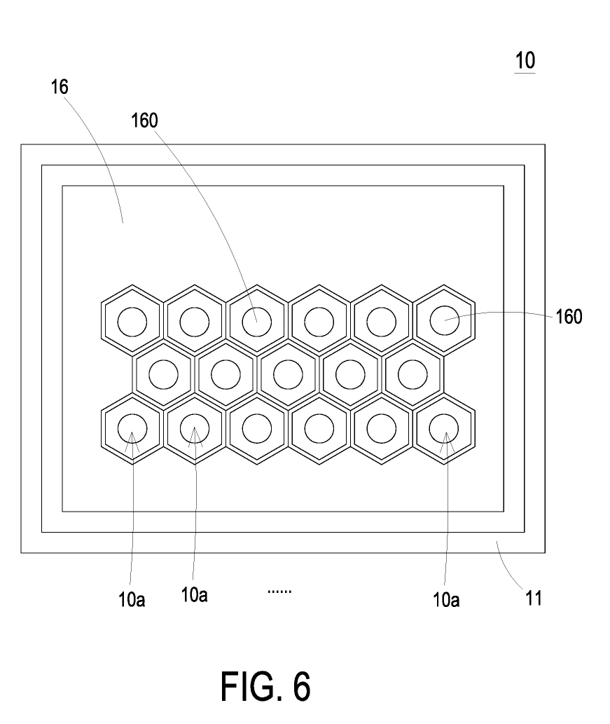

FIG. 5 is a schematic structural view illustrating a second aspect of the fluid actuating region of the fluid system. FIG. 6 is a schematic structural view illustrating a third aspect of the fluid actuating region of the fluid system. As shown in FIG. 5, in some other embodiments, a second aspect of the fluid-guiding units 10a of the fluid actuating region 10 are connected to each other in a ring-shaped arrangement. As shown in FIG. 6, in some other embodiments, a third aspect of the fluid-guiding units 10a of the fluid actuating region 10 are connected to each other in a honeycomb arrangement.

In some embodiments, the connections between the fluid-guiding units 10a and the driving circuit enhance the utilization flexibility of the fluid system 100. In addition, the fluid system 100 can be applied to various electronic components, and the fluid-guiding units 10a of the fluid system 100 may be enabled to transport fluid simultaneously so as to transport a great amount of the fluid according to the practical requirements. Moreover, any two of the fluid-guiding units 10a may be individually controlled to be driven or non-driven. For example, one of the fluid-guiding units 10a is driven, and the other one of the fluid-guiding units 10a is non-driven. In some other embodiments, any two of the fluid-guiding units 10a may be alternately driven, but not limited thereto. Consequently, the purpose of transporting various amount of the fluid and the purpose of reducing the power consumption can be achieved.

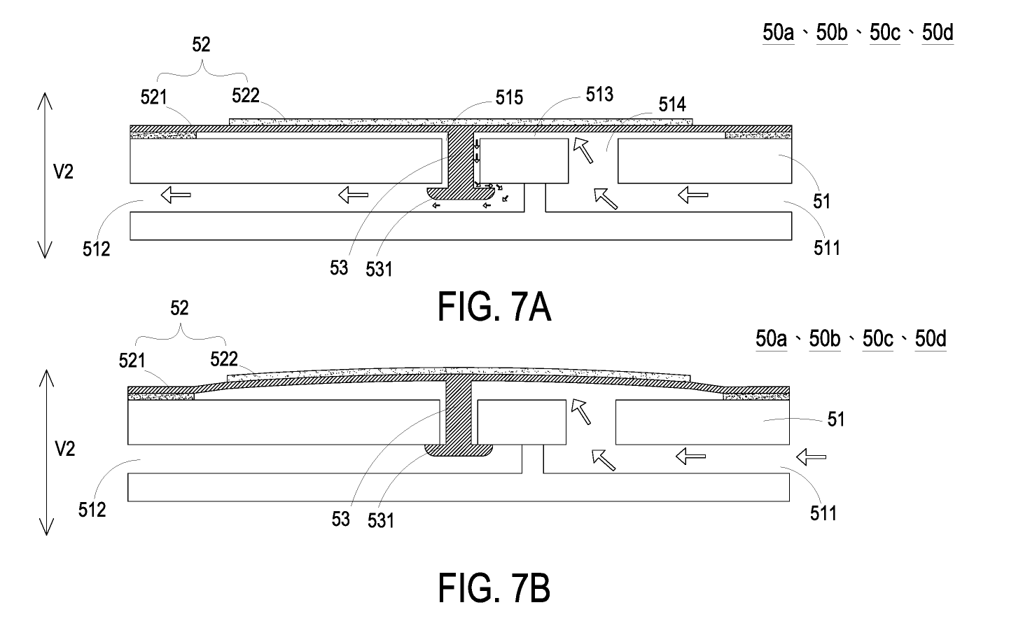

FIGS. 7A and 7B are schematic cross-sectional views illustrating actuations of a first aspect of a valve of the fluid system. Referring to FIGS. 7A and 7B, a first aspect of each of the valves 50a, 50b, 50c and 50d includes a base 51, a piezoelectric actuator 52 and a linking rod 53. The linking rod 53 has opposite first and second ends. Take an example as the valve 50a disposed in the sub-branch channel 21a. The structures and actuations of the valves 50c, 50b and 50d respectively disposed in the sub-branch channels 22a, 21b and 22b are similar to the structure and the actuations of the valve 50a disposed in the sub-branch channel 21a, and are not redundantly described herein. The base 51 has a first passage 511 and a second passage 512, which are in communication with the sub-branch channel 21a and are separated from each other by a partial structure of the base 51. A valve chamber 513 is formed between the base 51 and the piezoelectric actuator 52. The valve chamber 513 has a first outlet 514 and a second outlet 515. The first outlet 514 is in communication with the first passage 511, and the second outlet 515 is in communication with the second passage 512. The piezoelectric actuator 52 includes a carrier plate 521 and a piezoelectric ceramic plate 522. The carrier plate 521 has opposite first and second surfaces. The carrier plate 521 may be made of a flexible material. The piezoelectric ceramic plate 522 is attached on the first surface of the carrier plate 521 and is electrically connected to the controller 60. The piezoelectric actuator 52 is located over the valve chamber 513. The first end of the linking rod 53 is connected to the second surface of the carrier plate 521. The linking rod 53 extends into the second outlet 515 and is movable within the second outlet 515 in a second vertical direction (V2). A sealing part 531 is formed at the second end of the linking rod 53 for sealing the second outlet 515. The sealing part 531 has a cross-sectional area with a diameter greater than a diameter of the second outlet 515. Preferably but not exclusively, the sealing part 531 may be a flat plate structure or a mushroom-shaped structure.

As shown in FIG. 7A, when the piezoelectric actuator 52 of the valve 50a is non-driven, the linking rod 53 is at an initial position and the second outlet 515 is opened. That is, a gap is formed between the sealing part 531 and the second outlet 515, such that the second passage 512, the valve chamber 513, the first outlet 514 and the first passage 511 are in communication with each other and are in communication with the sub-branch channel 21a for allowing the fluid to flow therethrough. On the contrary, as shown in FIG. 7B, when the piezoelectric actuator 52 is driven, the carrier plate 521 is driven to undergo a bending deformation away from the base 51 by the piezoelectric ceramic plate 522, so that the linking rod 53 is driven by the carrier plate 521 to move relative to the base 51. Consequently, the second outlet 515 is sealingly covered by the sealing part 531. Since the second outlet 515 is sealingly closed by the sealing part 531, the fluid cannot be transported through the second outlet 515. As above-mentioned actuations, when the piezoelectric actuator 52 of the valve 50a is non-driven, the sub-branch channel 21a is maintained in an opened state, and when the piezoelectric actuator 52 of the valve 50a is driven, the sub-branch channel 21a is in a closed state. In other words, by controlling a communication state of the second passage 512 of the valve 50a, the fluid can be controlled to be discharged out through the sub-branch channel 21a.

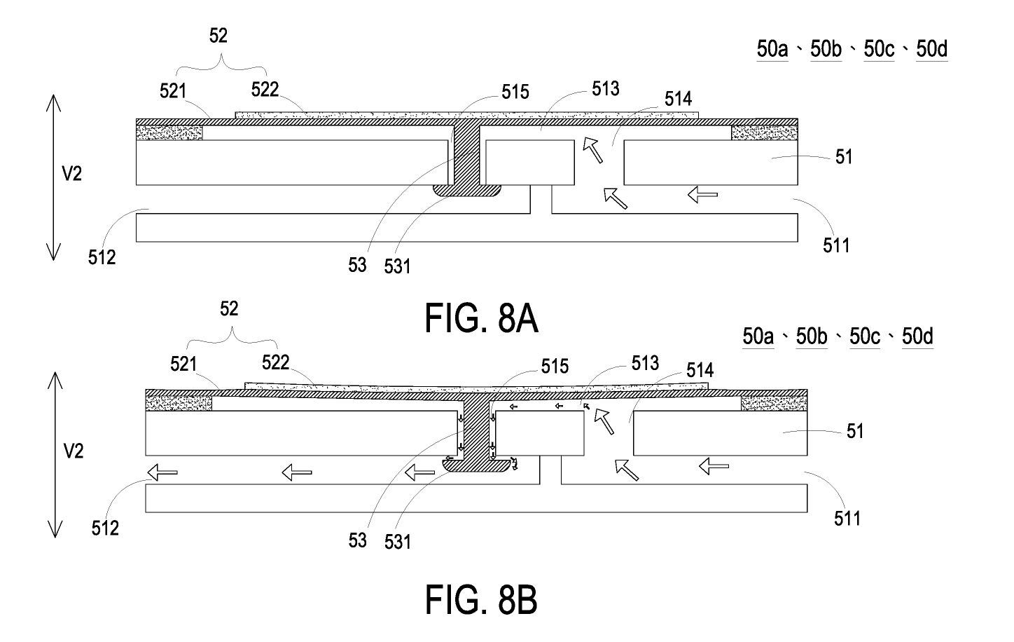

FIGS. 8A and 8B are schematic cross-sectional views illustrating actuations of a second aspect of the valve of the fluid system. Referring to FIGS. 8A and 8B, the structure of a second aspect of the valves 50a, 50b, 50c and 50d is similar to that of the first aspect illustrated in FIGS. 7A and 7B, and is not further described hereafter.

As shown in FIG. 8A, when the piezoelectric actuator 52 of the valve 50a is non-driven, the linking rod 53 is at an initial position and the second outlet 515 is closed. That is, the second outlet 515 is sealingly covered by the sealing part 531. Since the second outlet 515 is sealingly closed by the sealing part 531, the fluid cannot be transported through the second outlet 515. As shown in FIG. 8B, when the piezoelectric actuator 52 is driven, the carrier plate 521 is driven to undergo a bending deformation toward the base 51 by the piezoelectric ceramic plate 522, so that the linking rod 53 is driven by the carrier plate 521 to move relative to the base 51. Under this circumstance, a gap is formed between the sealing part 531 and the second outlet 515, such that the second passage 512, the valve chamber 513, the first outlet 514 and the first passage 511 are in communication with each other and in communication with the sub-branch channel 21a for allowing the fluid to flow therethrough. As above-mentioned actuations, when the piezoelectric actuator 52 of the valve 50a is non-driven, the sub-branch channel 21a is maintained in the closed state, and when the piezoelectric actuator 52 of the valve 50a is driven, the sub-branch channel 21a is in the opened state. In other words, by controlling the communication state of the second passage 512 of the valve 50a, the fluid can be controlled to be discharged out through the sub-branch channel 21a.

From the above descriptions, the present disclosure provides the fluid system. The at least one fluid-guiding unit transports the fluid to the convergence chamber, and the valves disposed in the branch channels control and adjust the amount, the flow rate and the pressure of the fluid to be discharged from the fluid system. In addition, the numbers, arrangements and driving methods of the at least one fluid-guiding unit and the branch channels can be flexibly varied according to the practical requirements. In other words, the fluid system of the present disclosure can provide the efficacy of transporting a great amount of fluid in a high performance and high flexible manner according to various applied devices and required amount of fluid to be transported.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A fluid system, produced by an integrated method, and comprising:
a fluid actuating region including at least one fluid-guiding unit, wherein the at least one fluid-guiding unit includes:
an inlet plate having at least one inlet aperture;
a substrate;
a resonance plate having a central aperture, wherein a first chamber is formed between the resonance plate and the inlet plate;
an actuating plate having a suspension part, an outer frame part and at least one interspace;
a piezoelectric member attached on a surface of the suspension part of the actuating plate; and
an outlet plate having an outlet aperture,
wherein the inlet plate, the substrate, the resonance plate, the actuating plate and the outlet plate are stacked sequentially, a gap formed between the resonance plate and the actuating plate is defined as a second chamber, and a third chamber is formed between the actuating plate and the outlet plate, wherein while the piezoelectric member drives the actuating plate to undergo a bending vibration in resonance, a pressure difference is formed between the second chamber and the third chamber so that fluid is inhaled into the first chamber through the at least one inlet aperture, is transported to the second chamber through the central aperture of the resonance plate, is transported to the third chamber through the at least one interspace, and is finally discharged out from the outlet aperture of the outlet plate;
a fluid channel in communication with the outlet aperture of the fluid actuating region, and having a plurality of branch channels, wherein the fluid transported in the fluid actuating region is split by the branch channels, so that a required amount of the fluid to be transported is determined;
a convergence chamber in communication with the fluid channel and disposed for allowing the fluid to be accumulated therein;
a sensor disposed in the fluid channel for measuring the fluid within the fluid channel; and
a plurality of valves respectively disposed in the branch channels, wherein the fluid is discharged out through the branch channels by controlling opened/closed states of the valves.

2. The fluid system according to claim 1, wherein the fluid actuating region includes a plurality of fluid-guiding units connected to each other in series for transporting the fluid.

3. The fluid system according to claim 1, wherein the fluid actuating region includes a plurality of fluid-guiding units connected to each other in parallel for transporting the fluid.

4. The fluid system according to claim 1, wherein the fluid actuating region includes a plurality of fluid-guiding units connected to each other both in series and in parallel for transporting the fluid.

5. The fluid system according to claim 1, wherein the fluid actuating region includes a plurality of fluid-guiding units connected to each other in a ring-shape arrangement for transporting the fluid.

6. The fluid system according to claim 1, wherein the fluid actuating region includes a plurality of fluid-guiding units connected to each other in a honeycomb arrangement for transporting the fluid.

7. The fluid system according to claim 1, wherein the lengths of the branch channels are preset according to the required amount of the fluid to be transported.

8. The fluid system according to claim 1, wherein the widths of the branch channels are preset according to the required amount of the fluid to be transported.

9. The fluid system according to claim 1, wherein each of the valves includes:
a base having a first passage and a second passage, wherein the first passage and the second passage are separated from each other and in communication with a corresponding one of the branch channels;
a piezoelectric actuator including a carrier plate and a piezoelectric ceramic plate, wherein the piezoelectric ceramic plate is attached on a first surface of the carrier plate, a valve chamber is formed between the base and the piezoelectric actuator, and has a first outlet in communication with the first passage and a second outlet in communication with the second passage; and
a linking rod having a first end and a second end, extending into the second outlet and being movable within the second outlet, wherein the first end of the linking rod is connected to a second surface of the carrier plate, wherein a sealing part is formed at the second end of the linking rod for sealing the second outlet, wherein the sealing part has a cross-sectional area with a diameter greater than a diameter of the second outlet,
and wherein when the piezoelectric actuator is driven to drive a deformation of the carrier plate, the sealing part of the linking rod is correspondingly moved to close or open the second outlet, so that the fluid is controlled to be discharged out through the corresponding one of branch channels.

10. The fluid system according to claim 1, wherein the opened/closed states of the valves are controlled by a controller.

11. The fluid system according to claim 10, wherein the controller and the at least one fluid-guiding unit are systematically packaged as an integrated structure.

12. The fluid system according to claim 1, wherein the branch channels are connected to each other in series.

13. The fluid system according to claim 1, wherein the branch channels are connected to each other in parallel.

14. The fluid system according to claim 1, wherein the branch channels are connected to each other both in series and in parallel.

15. A fluid system, produced by an integrated method, and comprising:
at least one fluid actuating region including at least one fluid-guiding unit, wherein the at least one fluid-guiding unit includes:
at least one inlet plate having at least one inlet aperture;
at least one substrate;
at least one resonance plate having at least one central aperture, wherein at least one first chamber is formed between the resonance plate and the inlet plate;
at least one actuating plate having at least one suspension part, at least one outer frame part and at least one interspace;
at least one piezoelectric member attached on a surface of the suspension part of the actuating plate; and
at least one outlet plate having at least one outlet aperture,
wherein the inlet plate, the substrate, the resonance plate, the actuating plate and the outlet plate are stacked sequentially, at least one gap formed between the resonance plate and the actuating plate is defined as at least one second chamber, and at least one third chamber is formed between the actuating plate and the outlet plate, wherein while the piezoelectric member drives the actuating plate to undergo a bending vibration in resonance, at least one pressure difference is formed between the second chamber and the third chamber so that fluid is inhaled into the first chamber through the at least one inlet aperture, is transported to the second chamber through the central aperture of the resonance plate, is transported to the third chamber through the at least one interspace, and is finally discharged out from the outlet aperture of the outlet plate;
at least one fluid channel in communication with the outlet aperture of the fluid actuating region, and having a plurality of branch channels, wherein the fluid transported in the fluid actuating region is split by the branch channels, so that a required amount of the fluid to be transported is determined;
at least one convergence chamber in communication with the fluid channel and disposed for allowing the fluid to be accumulated therein;
at least one sensor disposed in the fluid channel for measuring the fluid within the fluid channel; and
a plurality of valves respectively disposed in the branch channels, wherein the fluid is discharged out through the branch channels by controlling opened/closed states of the valves.
